(19) United States
(12) Patent Application Publication
(10) Pub. No.: US 2025/0056540 A1
(43) Pub. Date: Feb. 13, 2025

(54) PARALLEL UPLINK TRANSMISSION

(71) Applicant: Nokia Technologies Oy, Espoo (FI)

(72) Inventors: Matha DEGHEL, Paris (FR); Keeth Saliya Jayasinghe LADDU, Espoo (FI)

(73) Assignee: Nokia Technologies Oy, Espoo (FI)

(21) Appl. No.: 18/722,816

(22) PCT Filed: Dec. 23, 2021
(86) PCT No.: PCT/EP2021/087563

§ 371 Date: Jun. 21, 2024

(51) Int. Cl. H04W 72/20; H04B 7/022

(52) U.S. Cl. CPC H04W 72/20; H04B 7/022

(57) ABSTRACT

Various example embodiments relate to configuration of uplink transmissions. An apparatus may transmit a first uplink transmission with a first uplink configuration and a second uplink transmission with a second uplink configuration. The first and second uplink transmissions may at least partially overlap. The first and second uplink configurations may comprise first and a second initial cyclic shifts, first and second orthogonal cover codes, first and second reference signal initializations, first and second scrambling sequence initialization, and/or first and second scrambling sequences for the first uplink transmission and the second uplink transmission, respectively.

### TECHNICAL FIELD

Various example embodiments generally relate to the field of wireless communications. Some example embodiments relate to uplink transmission to multiple transmission-reception points (TRP).

### BACKGROUND

Wireless communication systems may enable simultaneous communication with multiple transmission-reception points (TRP), for example in order to improve reliability or capacity of uplink transmissions from devices, such as for example user equipment (UE). A UE may be configured with multiple antenna panels or beamforming for directional uplink transmission. Simultaneous uplink transmissions may however interfere with each other, for example due to secondary propagation paths and reflections occurring in the radio channel.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments improve reliability of at least partially simultaneous uplink transmissions. This and other benefits may be achieved by the features of the independent claims. Further example embodiments are provided in the dependent claims, the description, and the drawings.

According to a first aspect, an apparatus may comprise at least one processor; and at least one memory including computer program code; the at least one memory and the computer program code configured to, with the at least one processor, cause the apparatus at least to: receive, from a network node, an indication of first and second uplink configurations; and transmit a first uplink transmission of at least two overlapping uplink transmissions with the first uplink configuration and a second uplink transmission of the at least two overlapping uplink transmissions with the second uplink configuration, and/or transmit at least one non-overlapping uplink transmission with the first uplink configuration, the second uplink configuration, or a default uplink configuration.

According to an example embodiment of the first aspect, the first and second uplink transmission configurations comprise at least one of: a first initial cyclic shift for the first uplink transmission and a second initial cyclic shift for the second uplink transmission, a first orthogonal cover code for the first uplink transmission and a second orthogonal cover code for the second uplink transmission, a first reference signal initialization for the first uplink transmission and a second reference signal initialization for the second uplink transmission, a first scrambling sequence initialization for the first uplink transmission and a second scrambling sequence initialization for the second uplink transmission, or a first scrambling sequence for the first uplink transmission and a second scrambling sequence for the second uplink transmission.

According to an example embodiment of the first aspect, the at least one memory and the computer program code are further configured to, with the at least one processor, cause the apparatus to: directionally transmit the first uplink transmission towards a first transmission-reception point; and directionally transmit the second uplink transmission towards a second transmission-reception point.

According to an example embodiment of the first aspect, the indication of the first uplink configuration and the second uplink configuration is received in at least one of downlink control information, medium access control control element, or radio resource control signaling.

According to an example embodiment of the first aspect, the at least one memory and the computer program code are further configured to, with the at least one processor, cause the apparatus to: receive an indication of an association of the first uplink configuration and the second uplink configuration with a set of uplink transmission resources or an uplink transmission format.

According to an example embodiment of the first aspect, the at least one memory and the computer program code are further configured to, with the at least one processor, cause the apparatus to: transmit the first uplink transmission with the first uplink configuration and the second uplink transmission with the second uplink configuration, in response to determining that at least one uplink transmission resource determined for the first uplink transmission and the second uplink transmission belong to the set of uplink transmission resources or that the first and second uplink transmissions are transmitted with the uplink transmission format.

According to an example embodiment of the first aspect, the indication of the association of the first uplink configuration and the second uplink configuration with the set of uplink transmission resources or the uplink transmission format is received in radio resource control signaling.

According to an example embodiment of the first aspect, the first and second uplink transmissions comprise at least one of: uplink repetitions sharing same data content, different data content, or different subsets of data content of a frequency resource allocation.

According to an example embodiment of the first aspect, the first uplink configuration is associated with or configured for the first transmission-reception point and the second uplink configuration is associated with or configured for the second transmission-reception point

According to an example embodiment of the first aspect, the first transmission-reception point is identified based on at least one of a first control resource set pool index, a first control resource set identifier, a first beam failure detection reference signal set, a first sounding reference signal resource set, or a first physical cell identifier, and wherein the second transmission-reception point is identified based on at least one of a second control resource set pool index, a second control resource set identifier, a second beam failure detection reference signal set, a second sounding reference signal resource set, or a second physical cell identifier.

According to an example embodiment of the first aspect, the at least one memory and the computer program code are further configured to, with the at least one processor, cause the apparatus to: use the first reference signal initialization for a demodulation reference signal of the first uplink transmission; and use the second reference signal initialization for a demodulation reference signal of the second uplink transmission.

According to an example embodiment of the first aspect, the at least one memory and the computer program code are further configured to, with the at least one processor, cause the apparatus to: use a first cyclic shift or the first orthogonal cover code for the demodulation reference signal of the first uplink transmission; and use a second cyclic shift or the second orthogonal cover code for the demodulation reference signal of the second uplink transmission.

According to an example embodiment of the first aspect, the at least one memory and the computer program code are further configured to, with the at least one processor, cause the apparatus to: receive an indication to use or not to use different uplink configurations for the at least two overlapping uplink transmissions; and determine to use or not to use one of the first and second uplink configurations for subsequent instances of the first and second uplink transmissions based on the indication to use or not to use the different uplink configurations.

According to an example embodiment of the first aspect, the at least one memory and the computer program code are further configured to, with the at least one processor, cause the apparatus to: directionally transmit a subsequent instance of the first uplink transmission with the second uplink configuration towards the first transmission-reception point; and directionally transmit a subsequent instance of the second uplink transmission with the first uplink configuration to the second transmission-reception point.

According to a second aspect, an apparatus may comprise at least one processor; and at least one memory including computer program code; the at least one memory and the computer program code configured to, with the at least one processor, cause the apparatus at least to: transmit to a user equipment, an indication of a first uplink configuration and a second uplink configuration, wherein the first and second uplink configurations are configured for at least two overlapping uplink transmissions from the user equipment; and receive a first uplink transmission of the at least two overlapping uplink transmissions with the first uplink configuration or a second uplink transmission of the at least two overlapping uplink transmissions with the second uplink configuration.

According to an example embodiment of the second aspect, the first and second uplink configurations comprise at least one of: a first initial cyclic shift for the first uplink transmission and a second initial cyclic shift for the second uplink transmission, a first orthogonal cover code for the first uplink transmission and a second orthogonal cover code for the second uplink transmission, a first reference signal initialization for the first uplink transmission and a second reference signal initialization for the second uplink transmission, a first scrambling sequence initialization for the first uplink transmission and a second scrambling sequence initialization for the second uplink transmission, or a first scrambling sequence for the first uplink transmission and a second scrambling sequence for the second uplink transmission.

According to an example embodiment of the second aspect, the indication of the first uplink configuration and the second uplink configuration is transmitted in at least one of downlink control information, medium access control control element, or radio resource control signaling.

According to an example embodiment of the second aspect, the at least one memory and the computer program code are further configured to, with the at least one processor, cause the apparatus to: transmit an indication of an association of the first uplink configuration and the second uplink configuration with a set of uplink transmission resources or an uplink transmission format.

According to an example embodiment of the second aspect, the indication of the association of the first uplink configuration and the second uplink configuration with the set of uplink transmission resources or the uplink transmission format is transmitted in radio resource control signaling.

According to an example embodiment of the second aspect, the first and second uplink transmissions comprise at least one of: uplink repetitions sharing same data content, different data content, or different subsets of data content of a frequency resource allocation.

According to an example embodiment of the second aspect, the first uplink configuration is associated with or configured for a first transmission-reception point and wherein the second uplink configuration is associated with or configured for a second transmission-reception point

According to an example embodiment of the second aspect, the first transmission-reception point is identified based on at least one of a first control resource set pool index, a first control resource set identifier, a first beam failure detection reference signal set, a first sounding reference signal set or a first physical cell identifier, and wherein the second transmission-reception point is identified based on at least one of a second control resource set pool index, a second control resource set identifier, a second beam failure detection reference signal set, a second sounding reference signal set, or a second physical cell identifier.

According to an example embodiment of the second aspect, the at least one memory and the computer program code are further configured to, with the at least one processor, cause the apparatus to: transmit an indication to use or not to use the second uplink configuration for the at least two overlapping uplink transmissions.

According to an example embodiment of the second aspect, the at least one memory and the computer program code are further configured to, with the at least one processor, cause the apparatus to: transmit a request for swapping uplink configurations for at least one subsequent pair of overlapping uplink transmissions.

According to a third aspect, a method comprises: receiving, from a network node, an indication of first and second uplink configurations; and transmitting a first uplink transmission of at least two overlapping uplink transmissions with the first uplink configuration and a second uplink transmission of the at least two overlapping uplink transmissions with the second uplink configuration, and/or transmitting at least one non-overlapping uplink transmission with the first uplink configuration, the second uplink configuration, or a default uplink configuration.

According to an example embodiment of the third aspect, the first and second uplink transmission configurations comprise at least one of: a first initial cyclic shift for the first uplink transmission and a second initial cyclic shift for the second uplink transmission, a first orthogonal cover code for the first uplink transmission and a second orthogonal cover code for the second uplink transmission, a first reference signal initialization for the first uplink transmission and a second reference signal initialization for the second uplink transmission, a first scrambling sequence initialization for the first uplink transmission and a second scrambling sequence initialization for the second uplink transmission, or a first scrambling sequence for the first uplink transmission and a second scrambling sequence for the second uplink transmission.

According to an example embodiment of the third aspect, the method further comprises: directionally transmitting the first uplink transmission towards a first transmission-reception point; and directionally transmitting the second uplink transmission towards a second transmission-reception point.

According to an example embodiment of the third aspect, the indication of the first uplink configuration and the second uplink configuration is received in at least one of downlink control information, medium access control control element, or radio resource control signaling.

According to an example embodiment of the third aspect, the method further comprises: receiving an indication of an association of the first uplink configuration and the second uplink configuration with a set of uplink transmission resources or an uplink transmission format.

According to an example embodiment of the third aspect, the method further comprises: transmitting the first uplink transmission with the first uplink configuration and the second uplink transmission with the second uplink configuration, in response to determining that at least one uplink transmission resource determined for the first uplink transmission and the second uplink transmission belong to the set of uplink transmission resources or that the first and second uplink transmissions are transmitted with the uplink transmission format.

According to an example embodiment of the third aspect, the indication of the association of the first uplink configuration and the second uplink configuration with the set of uplink transmission resources or the uplink transmission format is received in radio resource control signaling.

According to an example embodiment of the third aspect, the first and second uplink transmissions comprise at least one of: uplink repetitions sharing same data content, different data content, or different subsets of data content of a frequency resource allocation.

According to an example embodiment of the third aspect, the first uplink configuration is associated with or configured for the first transmission-reception point and the second uplink configuration is associated with or configured for the second transmission-reception point

According to an example embodiment of the third aspect, the first transmission-reception point is identified based on at least one of a first control resource set pool index, a first control resource set identifier, a first beam failure detection reference signal set, a first sounding reference signal resource set, or a first physical cell identifier, and wherein the second transmission-reception point is identified based on at least one of a second control resource set pool index, a second control resource set identifier, a second beam failure detection reference signal set, a second sounding reference signal resource set, or a second physical cell identifier.

According to an example embodiment of the third aspect, the method further comprises: using the first reference signal initialization for a demodulation reference signal of the first uplink transmission; and using the second reference signal initialization for a demodulation reference signal of the second uplink transmission.

According to an example embodiment of the third aspect, the method further comprises: using a first cyclic shift or the first orthogonal cover code for the demodulation reference signal of the first uplink transmission; and using a second cyclic shift or the second orthogonal cover code for the demodulation reference signal of the second uplink transmission.

According to an example embodiment of the third aspect, the method further comprises: receiving an indication to use or not to use different uplink configurations for the at least two overlapping uplink transmissions; and determining to use or not to use one of the first and second uplink configurations for subsequent instances of the first and second uplink transmissions based on the indication to use or not to use the different uplink configurations.

According to an example embodiment of the third aspect, the method further comprises: directionally transmitting a subsequent instance of the first uplink transmission with the second uplink configuration towards the first transmission-reception point; and directionally transmitting a subsequent instance of the second uplink transmission with the first uplink configuration to the second transmission-reception point.

According to a fourth aspect, a method comprises: transmitting to a user equipment, an indication of a first uplink configuration and a second uplink configuration, wherein the first and second uplink configurations are configured for at least two overlapping uplink transmissions from the user equipment; and receiving a first uplink transmission of the at least two overlapping uplink transmissions with the first uplink configuration or a second uplink transmission of the at least two overlapping uplink transmissions with the second uplink configuration.

According to an example embodiment of the fourth aspect, the first and second uplink configurations comprise at least one of: a first initial cyclic shift for the first uplink transmission and a second initial cyclic shift for the second uplink transmission, a first orthogonal cover code for the first uplink transmission and a second orthogonal cover code for the second uplink transmission, a first reference signal initialization for the first uplink transmission and a second reference signal initialization for the second uplink transmission, a first scrambling sequence initialization for the first uplink transmission and a second scrambling sequence initialization for the second uplink transmission, or a first scrambling sequence for the first uplink transmission and a second scrambling sequence for the second uplink transmission.

According to an example embodiment of the fourth aspect, the indication of the first uplink configuration and the second uplink configuration is transmitted in at least one of downlink control information, medium access control control element, or radio resource control signaling.

According to an example embodiment of the fourth aspect, the method further comprises: transmitting an indication of an association of the first uplink configuration and the second uplink configuration with a set of uplink transmission resources or an uplink transmission format.

According to an example embodiment of the fourth aspect, the indication of the association of the first uplink configuration and the second uplink configuration with the set of uplink transmission resources or the uplink transmission format is transmitted in radio resource control signaling.

According to an example embodiment of the fourth aspect, the first and second uplink transmissions comprise at least one of: uplink repetitions sharing same data content, different data content, or different subsets of data content of a frequency resource allocation.

According to an example embodiment of the fourth aspect, the first uplink configuration is associated with or configured for a first transmission-reception point and wherein the second uplink configuration is associated with or configured for a second transmission-reception point

According to an example embodiment of the fourth aspect, the first transmission-reception point is identified based on at least one of a first control resource set pool index, a first control resource set identifier, a first beam failure detection reference signal set, a first sounding reference signal set or a first physical cell identifier, and wherein the second transmission-reception point is identified based on at least one of a second control resource set pool index, a second control resource set identifier, a second beam failure detection reference signal set, a second sounding reference signal set, or a second physical cell identifier.

According to an example embodiment of the fourth aspect, the method further comprises: transmitting an indication to use or not to use the second uplink configuration for the at least two overlapping uplink transmissions.

According to an example embodiment of the fourth aspect, the method further comprises: transmitting a request for swapping uplink configurations for at least one subsequent pair of overlapping uplink transmissions.

According to a fifth aspect a computer program or a computer program product may comprise instructions for causing an apparatus to perform at least the following: receiving, from a network node, an indication of first and second uplink configurations; and transmitting a first uplink transmission of at least two overlapping uplink transmissions with the first uplink configuration and a second uplink transmission of the at least two overlapping uplink transmissions with the second uplink configuration, and/or transmitting at least one non-overlapping uplink transmission with the first uplink configuration, the second uplink configuration, or a default uplink configuration. The computer program may further comprise instructions for causing the apparatus to perform any example embodiment of the method of the third aspect.

According to a sixth aspect a computer program or a computer program product may comprise instructions for causing an apparatus to perform at least the following: transmitting to a user equipment, an indication of a first uplink configuration and a second uplink configuration, wherein the first and second uplink configurations are configured for at least two overlapping uplink transmissions from the user equipment; and receiving a first uplink transmission of the at least two overlapping uplink transmissions with the first uplink configuration or a second uplink transmission of the at least two overlapping uplink transmissions with the second uplink configuration. The computer program may further comprise instructions for causing the apparatus to perform any example embodiment of the method of the fourth aspect.

According to a seventh aspect an apparatus may comprise: means for receiving, from a network node, an indication of first and second uplink configurations; and means for transmitting a first uplink transmission of at least two overlapping uplink transmissions with the first uplink configuration and a second uplink transmission of the at least two overlapping uplink transmissions with the second uplink configuration, and/or means for transmitting at least one non-overlapping uplink transmission with the first uplink configuration, the second uplink configuration, or a default uplink configuration. The apparatus may further comprise means for performing any example embodiment of the method of the third aspect

According to an eighth aspect an apparatus may comprise: means for transmitting to a user equipment, an indication of a first uplink configuration and a second uplink configuration, wherein the first and second uplink configurations are configured for at least two overlapping uplink transmissions from the user equipment; and receiving a first uplink transmission of the at least two overlapping uplink transmissions with the first uplink configuration or a second uplink transmission of the at least two overlapping uplink transmissions with the second uplink configuration. The apparatus may further comprise means for performing any example embodiment of the method of the fourth aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network;

FIG. 2 illustrates an example of an apparatus configured to practice one or more example embodiments;

FIG. 3 illustrates an example of configuring and applying different uplink configurations for uplink transmissions to two transmission-reception points;

FIG. 4 illustrates an example of applying different orthogonal cover codes for overlapping uplink transmissions to two transmission-reception points;

FIG. 5 illustrates an example of applying different initial cyclic shifts for overlapping uplink transmissions to two transmission-reception points;

FIG. 6 illustrates an example of applying different demodulation reference signal (DMRS) sequence initializations for overlapping uplink transmissions to two transmission-reception points;

FIG. 7 illustrates an example of applying different scrambling sequence initializations for partially overlapping uplink transmissions to two transmission-reception points;

FIG. 8 illustrates an example of a method for applying different uplink transmission configurations for uplink transmissions; and

FIG. 9 illustrates an example of a method for configuring different uplink transmission configurations for uplink transmissions.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In order to improve reliability, latency and/or capacity of uplink channel, a device may be configured to exploit parallel transmissions or repetitions fully or partially overlapping in time and/or frequency. For example, different transmissions may be transmitted using a different antenna panels and therefore essentially towards different TRPs. Similarly, signals may be received from different TRPs using different antenna panels. This enables to increase the multiplexing capability and, more generally, to increase transmission resource efficiency and also to achieve lower latency.

However, when parallel (e.g. at least partially overlapping in time) transmissions/repetitions are allowed, it may be desired to avoid or minimize interference between the different transmissions/repetitions. The interference may be for example caused by secondary paths and reflections of one transmission interfering with the other transmission(s). This issue may be severe for example in case of inter-cell M-TRP (multi-TRP) schemes where each uplink transmission may be transmitted towards a different TRP in a different cell. Therefore, the present disclosure provides methods for mitigating interference between parallel uplink transmissions overlapping partially or fully in time and/or frequency domain, and also for improving uplink resource efficiency in this case.

According to an example embodiment, an apparatus, for example UE, may transmit a first uplink transmission with a first uplink configuration and a second uplink transmission with a second uplink configuration. The first and second uplink transmissions may at least partially overlap. The first and second uplink transmission configurations may comprise first and a second initial cyclic shifts, first and second orthogonal cover codes, first and second reference signal sequence initializations, first and second scrambling sequence initialization, and/or first and second scrambling sequences for the first uplink transmission and the second uplink transmission, respectively. Further example embodiments are disclosed below.

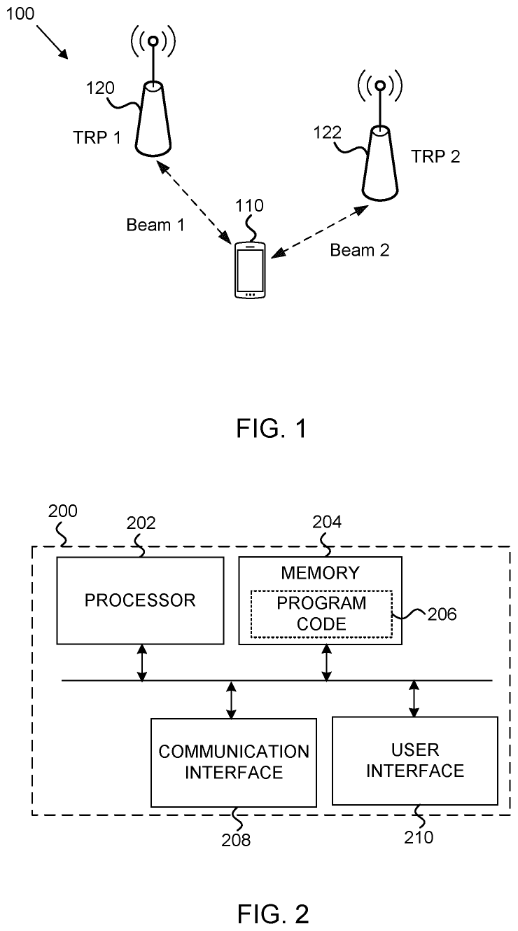

FIG. 1 illustrates an example of a communication network. Communication network 100 may comprise one or more devices, which may be also referred to as client nodes, user nodes, or user equipment (UE), an example of which is provided as UE 110. UE 110 may communicate with one or more access nodes, represented in this example by first and second TRPs 120, 122. UE 110 may in general communicate with any number (M) of TRPs. Communications between UE 110 and TRPs 120, 122 may be bidirectional and hence any of these entities may be configured to operate as a transmitter and/or a receiver.

UE 110 may support directive transmission and/or reception, for example by means of beamforming. For example, UE 110 may communicate with first TRP 120 using a first beam (Beam 1) and with second TRP 122 using a second beam (Beam 2). In beamforming multiple antenna elements may be configured to transmit the same signal. The signals may be configured to be combined in the air such that the composite signal is reinforced at a specific direction towards the targeted TRP. This not only enables the signal transmitted by UE 110 to be directed to a particular TRP, but it also improves reception of signals from respective TRP. Transmissions from a device to an access point, e.g. from UE 110 to TRP 120, may be referred to as uplink (UL) transmissions. Transmissions from an access node to a device may be referred to as downlink (DL) transmissions. Alternatively, UE 110 may be configured with multiple directional antenna panels and a suitable antenna panel may be selected for communication with a particular TRP.

Communication network 100 may further comprise one or more core network elements (not shown), for example network nodes, network devices, or network functions. The core network may example comprise an access and mobility management function (AMF) and/or user plane function (UPF), which enable TRPs 120, 122 to provide various communication services for UE 110. The TRPs 120, 122 may be configured to communicate with the core network elements over a communication interface, such as for example a control plane interface and/or a user plane interface (e.g. NG-C/U). An access node, such as TRP 120, may be also called a base station or a radio access network (RAN) node and it may be part of a RAN between the core network and the UE 110. Functionality of an access node, such as a 5th generation (5G) access point (gNB). may be distributed between a central unit (CU), for example a gNB-CU, and one or more distributed units (DU), for example gNB-DUs. It is therefore appreciated that access node functionality described herein may be implemented at a gNB, or divided between a gNB-CU and a gNB. Network elements such gNB, gNB-CU, and gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

Communication network 100 may be configured for example in accordance with the 5G digital cellular communication network, as defined by the 3rd Generation Partnership Project (3GPP). In one example, the communication network 100 may operate according to 3GPP 5G NR (New Radio). It is however appreciated that example embodiments presented herein are not limited to this example network and may be applied in any present or future wireless communication networks, or combinations thereof, for example other type of cellular networks, short-range wireless networks, broadcast or multicast networks, or the like.

Data communication in communication network 100 may be based on a protocol stack comprising various communication protocols and layers. Layers of the protocol stack may be configured to provide certain functionalities, for example based on the Open Systems Interconnection (OSI) model or a layer model of a particular standard, such as for example NR.

In one example, the protocol stack may comprise a service data adaptation protocol (SDAP) layer, which may, at the transmitter side, receive data from an application layer for transmission, for example one or more data packets. The SDAP layer may be configured to exchange data with a PDCP (packet data convergence protocol) layer. The PDCP layer may be responsible of generation of PDCP data packets, for example based on data obtained from the SDAP layer.

A radio resource control (RRC) layer, provided for example on top of the PDCP layer, may be configured to implement control plane functionality. RRC may refer to provision of radio resource related control data. RRC messages may be transmitted on various logical control channels such as for example a common control channel (CCCH) or a dedicated control channel (DCCH).

The PDCP layer may provide data to one or more instances of a radio link control (RLC) layer. For example, the PDCP data packets may be transmitted on one or more RLC transmission legs. RLC instance(s) may be associated with corresponding medium access control (MAC) instances of the MAC layer. The MAC layer may deliver the data to the physical layer for transmission.

The MAC layer may provide a mapping between logical channels of the upper layer(s) and transport channels, such as for example broadcast channel (BCH), paging channel (PCH), downlink shared channel (DL-SCH), uplink shared channel (UL-SCH), or random access channel (RACH). The MAC layer may be further configured to handle multiplexing and demultiplexing of MAC service data units (SDU). Furthermore, the MAC layer may provide error correction functionality based on packet retransmissions, for example according to the hybrid automatic repeat request (HARQ) process. The MAC layer may also carry control information, for example in MAC control elements (CE). This enables fast exchange of control information at the MAC layer without involving the upper layers.

The physical layer may provide data transmission services on physical layer channels such as for example the physical broadcast channel (PBCH), physical downlink control channel (PDCCH), physical downlink shared channel (PDSCH), physical uplink control channel (PUCCH), physical uplink shared channel (PUSCH), or physical random access channel (PRACH). The physical layer may for example perform modulation, forward error correction (FEC) coding, define a physical layer frame structure, etc., to transmit upper layer data at the physical channels. The physical channels may carry the transport channels. The physical layer may also carry signalling information, for example downlink control information (DCI). DCI may therefore comprise physical layer signalling information. DCI may be carried for example on PDCCH. DCI may include information about uplink resource allocation and/or information about downlink transmissions targeted to UE 110. DCI may be used by TRPs 120, 122 for example to schedule an uplink grant for UE 110, i.e., to inform UE 110 about transmission resources (e.g. subcarriers of particular orthogonal frequency division multiplexing (OFDM) symbols) assigned to UE 110 for uplink transmission. DCI may further indicate transmission parameters to be used for the uplink grant.

Transmission resources of the physical layer may comprise time and/or frequency resources. An example of a frequency resource is a subcarrier of an orthogonal frequency division multiplexing (OFDM) symbol. An example of a time resource is the OFDM symbol. A resource element (RE) may for example comprise one subcarrier position during one OFDM symbol. A resource element may be configured to carry one modulation symbol, for example a quadrature amplitude modulation (QAM) symbol comprising a real and/or an imaginary parts of the modulation symbol. Transmission resources may be assigned in blocks of resource elements. A resource block may comprise a group of resource elements (e.g. 12 REs).

The protocol stack may therefore comprise the following layers (lowest to highest): physical layer, MAC layer, RLC layer, and PDCP layer. RRC and SDAP protocols may be configured to operate on top of the PDCP layer. Corresponding protocol stacks may be applied at the UE 110 and TRPs 120, 122. Even though various operations have been described using the above protocol stack as an example, it is appreciated that the described example embodiments may be also applied to other protocol stacks having sufficiently similar functionality.

Configured uplink transmissions may comprise transmissions that use semi-statically or semi-persistently configured transmission resources. The transmissions, however, may not be necessarily periodic. Such transmissions may include configured grant (CG) PUSCH transmissions, scheduling requests (SR), sounding reference signals (SRS), periodic or semi-persistent channel state information (CSI), as well as PRACH transmissions. Unlike dynamically scheduled uplink transmission resources, for which each transmission may be scheduled by DCI, for semi-statically or semi-persistently configured transmissions a plurality of uplink transmissions or uplink transmission opportunities may be scheduled with a single control message, for example an RRC message.

Considering the example of CG PUSCH, UE 110 may be configured with semi-static PUSCH resources or semi-persistent PUSCH resources. In case of semi-static PUSCH resources, UE 110 may receive transmission parameters via RRC signaling, for example within an information element configuredGrantConfig. This information element may for example comprise a list of the transmission parameters (e.g. rrc-ConfiguredUplinkGrant). The transmission parameters may for example include an indication of time and/or frequency domain allocation of transmission resources, antenna port, modulation and coding scheme (MCS) (e.g. type of constellation and/or FEC code rate), and/or transport block (TB) size for the uplink transmission. A transport block may comprise a packet of data that is passed between the MAC layer and the physical layer.

In case of semi-persistent PUSCH resources, UE 110 may receive the information element configuredGrantConfig without the list of transmission parameters (rrc-ConfiguredUplinkGrant). The corresponding parameters may be provided in DCI associated with the uplink grant, which may also activate the semi-persistent PUSCH resources. In both cases, a subset of the transmission parameters may be alternatively provided by RRC signalling, e.g. RRC parameter pusch-Config.

### PUSCH Multi-Antenna Precoding Modes:

UE 110 may be configured with different modes for PUSCH multi-antenna precoding, for example codebook-based transmission and noncodebook-based transmission. For codebook-based dynamic grant (DG) PUSCH transmission, UE 110 may determine SRI (sounding reference signal (SRS) resource indicator) and TPMI (transmit precoding-matrix indicator) information (via precoding information and number of layers) from the corresponding fields in DCI. The SRI basically comprises uplink beam information for UE 110. TPMI comprises uplink precoder information for UE 110. For non-codebook-based DG PUSCH, in contrast to the codebook-based mode, UE 110 may determine its precoder and transmission rank based on downlink measurements. However, UE's selection of the precoder (and the number of layers) for each scheduled PUSCH may be modified by the network, for example if multiple SRS resources are configured, for example by omitting some columns from the precoder that UE 110 has selected. This latter step may be implemented for example by TRP 120 indicating, via SRI contained in DCI scheduling the PUSCH, a subset of the configured SRS resources.

### Modulation and Coding Scheme (MCS) for PUSCH:

UE 110 may determine MCS based on the MCS field indicated via DCI (at least for dynamically scheduled PUSCH), considering a (regular) MCS table. The considered table may depend on whether 256-QAM is configured or not. Some of the combinations/entries of the MCS field may be reserved and used for retransmission purposes. Also, an alternative MCS table providing lower spectral efficiency values may be configured—for example for targeting high reliability. An indication of which table, e.g. the regular (default) table or a more robust table, may be transmitted to UE 110 by TRP 120. Such indication may for example provided by the RNTI (radio network temporary identifier) associated with the scheduling of UE 110. For example, C-RNTI (cell-RNTI) may imply that the regular table should be used and MCS-C-RNTI may imply that the more robust table should be used.

### Time and Frequency Domain Resource Allocation for PUSCH:

Time-domain resource allocation/assignment for a scheduled transport block on PUSCH may be provided via a DCI field. This field may provide a row index to a time-domain resource allocation (TDRA) table. A row of the TDRA table may indicate at least one or more of: a slot offset, a start and length indicator (SLIV), and a mapping type (e.g. type A or type B).

The frequency-domain resource allocation/assignment for a scheduled transport block on PUSCH may be also provided via a DCI field. Types of frequency domain allocation may include type 0 and type 1. For type 0, a bitmap of resource block groups (RBG) signalled in DCI may be provided. Size of the bitmap may be equal to the number of resource blocks in the associated bandwidth part (BWP). To reduce the bitmap size while maintaining the allocation flexibility, a group of contiguous resource blocks as opposed to individual PRBs may be used; the size of the resource block group (RBG) may be determined by the size of the BWP. For type 1, starting resource block and number of resource blocks may be signalled in DCI-thus allowing contiguous allocations in frequency domain.

### PUSCH Repetition Type A:

PUSCH repetition via slot aggregation may be supported in a semi-static way, e.g., including no repetitions within a slot. An aggregation factor may be equal to 2, 4 or 8. This repetition operation may be also referred to as slot-based repetition.

### PUSCH Repetition Type B:

This repetition type enables resource allocation across slot-boundary and cross-DL-symbol scheduling for reduced latency without sacrificing reliability (e.g. multi-segment transmission). This enables enhanced PUSCH transmission for both dynamic-grant based PUSCH and configured-grant based PUSCH. For example, for a transport block, one dynamic uplink grant or one configured grant may schedule two or more PUSCH repetitions that can be in one slot, or across slot boundary in consecutive available slots. One nominal repetition may be segmented into one or more actual repetitions around semi-static downlink symbols and dynamically indicated/semi-statically configured invalid uplink symbols and/or at the slot boundary. For dynamic grant, the actual repetitions may be transmitted. There should not be conflict between the transmitted symbols and the dynamic downlink/flexible symbols (e.g. indicated by dynamic slot format indicator, SFI).

For configured grant, whether the actual repetition is transmitted or not may be determined as follows: the repetition is not transmitted if it conflicts with any dynamic DL/flexible symbols or if it conflicts with any semi-static flexible symbol if dynamic SFI is configured but not received.

Time-domain resource allocation is defined by S (starting symbol), L (length of each nominal repetition) and K (number of nominal repetitions), which may be signalled to UE 110 as part of the TDRA entry. TDRA field in DCI may indicate one of the entries in the TDRA table, for example S: 0 to 13, L: 1 to 14, K is {1, 2, 3, 4, 7, 8, 12, 16}. Maximum number of entries in the TDRA table may be for example equal to 64.

### PUCCH in NR

PUCCH may be used to carry uplink control information (UCI) such as for example scheduling request (SR), which may be also used or dedicated for beam failure recovery (BFR) request, link failure recovery request (LRR), hybrid automatic repeat request acknowledgement (HARQ-ACK), or channel state information (CSI).

PUCCH transmission may be configured in different formats. For example, PUCCH formats 2, 3 and 4 may carry HARQ-ACK, SR (which may be used for BFR or LRR), and/or CSI, whereas PUCCH formats 0 and 1 may carry SR and/or up to two HARQ-ACK bits. Each format may correspond to a format configuration in the PUCCH configuration. A PUCCH configuration may include parameter(s) related to PUCCH. In this configuration, UE 110 may be configured with a number of PUCCH resources. UCI may also include an indication of a MCS offset (or delta MCS).

### PUCCH Resource and PUCCH Resource Set:

A PUCCH resource may be identified based on one or more of the following parameters:
a PUCCH resource index, which may identify the PUCCH transmission resource(s),
a configuration for a PUCCH format, which may contain e.g. the number of OFDM symbols and the number of PRBs, orthogonal cover code (OCC) related parameters (e.g. for formats 1 and 4), a maximum code rate (maxCodeRate), a number of PRBs (nrofPRBs) which may represent the maximum number of PRBs (e.g. for formats 2 and 3), an index of the first PRB prior to frequency hopping or for no frequency hopping, or an index of the first PRB after frequency hopping (if any).
   An orthogonal cover code may comprise a sequence, e.g. a Walsh code sequence or a discrete cosine transform (DCT) sequence, that is used for spreading a signal, for example a DMRS. Applying multiple orthogonal cover codes to a group of signals enables to code division multiplex the signals such that a receiver, e.g. TRP 120, is enables to distinguish a particular signal from other transmissions.

UE 110 may be configured for multiple (e.g. up to four) sets of PUCCH resources, where each PUCCH resource set corresponds to a certain range of the amount of UCI payload. For example, PUCCH resource set 0 may handle UCI payloads up to two bits and thus may contain PUCCH formats 0 and 1, whereas the other PUCCH resource sets may contain any PUCCH format except formats 0 or 1. Enhancements for the PUCCH formats, mainly for unlicensed operation, may enable interlaced (PUCCH) transmission.

### PUCCH Resource Determination:

UE 110 may determine PUCCH resources based on at least one of: PRI (PUCCH resource indicator) in DCI, UCI payload size, first control channel element (CCE) index of the PDCCH carrying the DCI, the total number of CCEs in the control resource set (CORESET) on which the PDCCH carrying the DCI has been transmitted, or UCI configuration (such as for example SR configuration, CSI configuration, or SPS HARQ-ACK configuration). For example, when UE 110 determines to send UCI (including for example HARQ-ACK), the PUCCH resource set may be determined based on the UCI load. The PUCCH resource within this set may be determined using the PRI (PUCCH resource indicator) received in the DCI. On the other hand, the PUCCH resources for SR (scheduling request) and P-CSI (periodic CSI) may be semi-statically configured (e.g. by RRC), where the resources are given in the SR and CSI configurations.

### Single-TRP PUCCH Repetition Operation:

PUCCH repetition operation on multiple slots for PUCCH formats 1, 3 and 4 (and also other formats), enables to increase reliability and coverage for the transmitted UCI. For each of these formats, the repetition operation, if enabled, may include repeating the PUCCH carrying UCI over multiple consecutive slots. For example, for PUCCH formats 1, 3, or 4, UE 110 may be configured, e.g. via RRC signaling, with a number of slots for repetitions of a PUCCH transmission. This number may be denoted by N_{PUCCH}^{repeat} or nrofSlots. When applying PUCCH repetition operation, UE 110 may repeat the PUCCH transmission carrying the UCI over the preconfigured number of slots for repetition (e.g. over N_{PUCCH}^{repeat} Slots). The PUCCH repetition/transmission in each of the slots may have at least the same number of consecutive symbols and a same number of PRBs. The PUCCH repetition/transmission in each of the slots may have the same first symbol. UE 110 may be configured to perform or not to perform frequency hopping for PUCCH repetitions/transmissions in different slots.

### PUCCH and PUSCH Enhancements for Multi-TRP:

Objectives for enhancements on the support for multi-TRP deployment may include improving reliability and robustness for channels other than PDSCH (that is, PDCCH, PUSCH, and PUCCH) using multi-TRP and/or multi-panel configurations. A multi-TRP PUCCH scheme may include any of the following: multi-TRP inter-slot PUCCH repetition (scheme 1), multi-TRP intra-slot PUCCH repetition (scheme 3), multi-TRP PUCCH intra-slot beam hopping (scheme 2).

In addition, support of a single PUCCH resource may be provided. This implies that a single PUCCH resource may be used for different (e.g. time domain multiplexed) repetitions towards different TRPs. And, multiple (e.g. two) spatial relation infos may be indicated/activated for a PUCCH resource via a MAC control element (CE), for example at least in FR2 (3GPP frequency range 2). And, multiple (e.g. two) sets of power control parameters may be indicated/activated for a PUCCH resource via MAC CE, for example in FR1 (3GPP frequency range 1). The set of power control parameters may include at least one or more of: p0, pathloss reference signal identifier (PLRS ID), and a closed-loop index (or adjustment state). Parameter p0 may be provided in the power-control configuration. Parameter p0 may depend on at least the target data rate. Parameter p0 may be for example seen as a target received power. PLRS ID may comprise an index of the reference signal. Using this index UE 110 may calculate a downlink path-loss estimate. Closed-loop power control may be based on explicit power-control commands provided by a gNB. UE 110 may be configured with one or two power control loops or adjustment states.

A PUCCH repetition factor (i.e. number of PUCCH repetitions) may be dynamically indicated (e.g. via DCI) or configured via RRC. One approach for a dynamic indication of the PUCCH repetition factor may include associating PUCCH resource(s) (e.g. via RRC) with a PUCCH repetition factor. Thus, a PUCCH resource index (PRI), indicated by a TRP (e.g. via DCI), may be used by UE 110 to select a PUCCH resource associated with the required PUCCH repetition factor.

On the other hand, for the multi-TRP PUSCH enhancements, M-TRP time-domain multiplexed PUSCH repetition schemes based on 3GPP Rel-16 PUSCH repetition Type A and Type B may be applied. This may include indicating two beams/SRIs via DCI. Also, the same number of layers per TRP may be supported. For example, for codebook based PUSCH, UE 110 may be provided with two SRIs and two TPMIs (second field doesn't indicate number of layers) for PUSCH repetition operation. And for non-codebook based PUSCH, UE 110 may be provided with two SRIs (second field doesn't indicate number of layers) for PUSCH repetition operation.

### Parallel or Simultaneous UL Transmissions:

Further multi-TRP/multi-panel enhancements may include enabling simultaneous or parallel PUCCH/PUSCH and PUSCH/PUCCH/SRS/PRACH transmissions/repetitions from two UE panels. In parallel transmission, two or more uplink transmissions/repetitions may be transmitted at least partially simultaneously, i.e., either partially or fully overlapping in time domain. Under the multi-TRP context, in addition to the TDM (time domain multiplexing) PUCCH/PUSCH repetition operations, the following operations/schemes may be considered:
FDM (frequency domain multiplexing) PUCCH/PUSCH repetition/transmission operation, for which the same UCI/TB may be repeated at the same time (or at overlapping time domain resources) but on non-overlapping frequency domain allocations, and where each repetition is transmitted towards a different TRP. Alternatively, instead of repeating the same TB/UCI, different parts of PUCCH/PUSCH (where a part may be a time allocation, a frequency allocation, layer(s), and/or coded bits) may be transmitted towards different TRPs.
SDM (spatial domain multiplexing) PUCCH/PUSCH repetition/transmission operation, for which the same UCI/TB may be repeated at the same time and frequency domain allocations (or at least at overlapping time and frequency resources), and where each repetition is transmitted towards a different TRP. Alternatively, instead of repeating the same TB/UCI, different parts of PUCCH/PUSCH (where a part may be a time allocation, a frequency allocation, layer(s), and/or coded bits) may be transmitted towards different TRPs).

It should be noted that throughout the present disclosure, an uplink beam may also refer to spatial relation info, (separate) uplink transmission configuration indicator (TCI) state, joint or common TCI state, spatial filter, power control info (or power control parameters set), panel or panel ID, quasi-colocation type D (or other types), SRS resource indicator, or the like. More generally, all these terms may be interchangeably used, and generalized as parameters indicative of directionality of uplink transmission. Furthermore, a TRP may be identified by at least one of the following: an SRS resource set, a BFD-RS (beam failure detection reference signal) set, a subset/set of UL beams, a CORESET pool index (CORESETPoolIndex), if configured, or a physical cell identifier (PCI). An antenna panel of UE 110 may be identified by a panel ID. Alternatively, or additionally, a panel may be identified or associated by at least one DL RS (or more generally RS) or by an uplink beam. Beam information for PUCCH and/or PUSCH may be indicated/configured either based on the 3GPP Rel-15/Rel-16 framework or on the 3GPP Rel-17 unified TCI framework.

FIG. 2 illustrates an example embodiment of an apparatus 200, for example UE 110, TRPs 120, 122, or a component or a chipset of UE 110 or TRPs 120, 122. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices. In one example, apparatus 200 may use communication interface 208 to transmit or receive signaling information and/or data in accordance with at least one cellular communication protocol. Communication interface 208 may be configured to provide at least one wireless radio connection, such as for example a 3GPP mobile broadband connection (e.g. 3G, 4G, 5G, 6G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface may therefore comprise various means for transmitting and/or receiving radio signals, for example analog and/or digital circuitry such as for example baseband circuitry and/or radio frequency (RF) circuitry. Communication interface 208 may further comprise, or be configured to be coupled to, an antenna or a plurality of antennas to transmit and/or receive radio signals. One or more of the various types of connections may be also implemented as separate communication interfaces, which may be coupled or configured to be coupled to an antenna or a plurality of antennas.

Apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as for example software components. According to an embodiment, the apparatus comprises a processor or processor circuitry, such as for example a microcontroller, configured by the program code when executed to execute the embodiments of the operations and functionality described. A computer program or a computer program product may therefore comprise instructions for causing, when executed, apparatus 200 to perform the method(s) described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one method described herein. In one example, the means comprises the at least one processor 202, the at least one memory 204 including program code 206 configured to, when executed by the at least one processor, cause the apparatus 200 to perform the method. Apparatus 200 may for example comprise means for generating, transmitting, and/or receiving wireless communication signals, for example modulation circuitry, demodulation circuitry, radio frequency (RF) circuitry, or the like. The circuitry(ies) may be coupled to, or configured to be coupled to, one or more antennas to transmit and/or receive the wireless communication signals over an air interface.

Apparatus 200 may comprise a computing device such as for example an access point, a base station, a mobile phone, a smartphone, a tablet computer, a laptop, an internet of things (IoT) device, or the like. Examples of IoT devices include, but are not limited to, consumer electronics, wearables, sensors, and smart home appliances. In one example, apparatus 200 may comprise a vehicle such as for example a car. Although apparatus 200 is illustrated as a single device it is appreciated that, wherever applicable, functions of apparatus 200 may be distributed to a plurality of devices, for example to implement example embodiments as a cloud computing service.

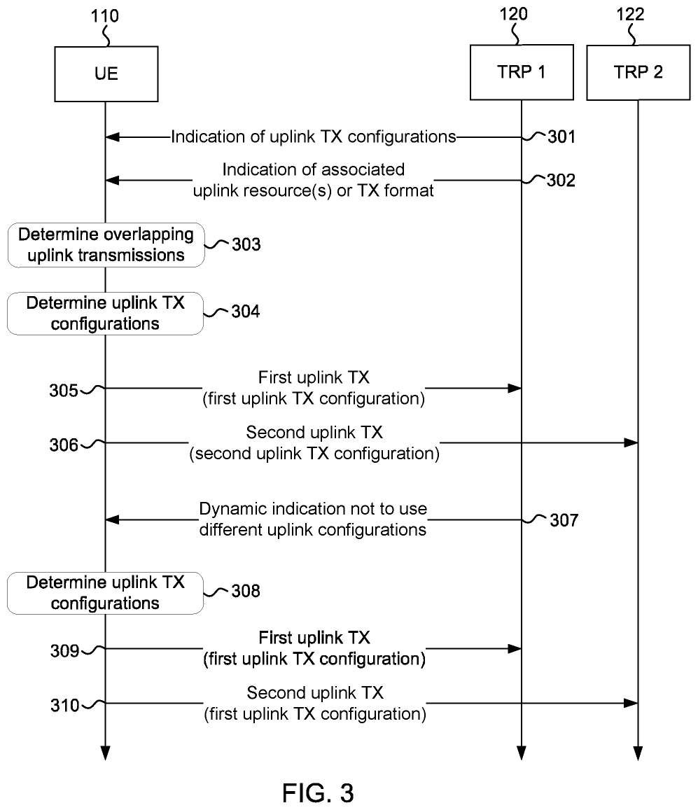

FIG. 3 illustrates an example of configuring and applying different uplink configurations for uplink transmissions to two transmission-reception points. The example embodiments described herein may be applied to any multi-TRP uplink scheme, for example multi-TRP PUCCH, PUSCH, or SRS scheme, such as an SDM scheme, an FDM scheme, a TDM scheme, and/or any combination of these schemes. Under any of the above schemes, at least two repetitions or transmissions corresponding to the same uplink control information (UCI), transport block (TB), or sounding reference signal (SRS) may be transmitted towards a plurality of different TRPs, e.g. by means of a plurality of uplink beams, SRIs, or (UL) TCI states (e.g. in FR2) and two power control parameters sets or SRIs (e.g. in FR1). It is noted that FIG. 3 presents one example of operations at UE 110 and TRPs 120, 122. Some of the described operations may not be present in all example embodiments and the example embodiments may also comprise additional features/operations described elsewhere in this specification.

At operation 301, the first TRP 120, or in general any suitable RAN node such as a gNB, may transmit an indication of multiple uplink transmission (TX) configurations to UE 110, for example an indication of a first uplink configuration and a second uplink configuration, which may be configured for first and second uplink transmissions, respectively. The indication may be provided for example in DCI, MAC CE, and/or RRC signaling. UE 110 may receive the indication. One or more of the following parameters may be indicated, for example via DCI and/or MAC CE (or even RRC): first initial cyclic, second initial cyclic shift, first OCC, second OCC, first DMRS sequence initialization, second DMRS sequence initialization, first scrambling sequence initialization, second scrambling sequence initialization, first scrambling sequence or identity, second scrambling sequence or identity. TRP 120 may transmit an indication of any one or more of these parameters. Alternatively, the different uplink configurations may be pre-configured at UE 110. However, providing the indication by first TRP 120 enables configuration of the parallel uplink transmissions by the network. The first and second uplink transmissions may be overlapping, either. partially or fully. The uplink transmissions may be overlapping at least in time domain. The first and second uplink transmissions may be fully or partially overlapping or non-overlapping in frequency domain. Even though some example embodiments have been described using first and second uplink transmissions as an example, it is appreciated that similar methods may be applied to more than two uplink transmissions, for example three or four uplink transmissions or in general a plurality of uplink transmissions.

The uplink transmissions may comprise PUCCH transmissions, PUSCH transmissions (e.g. PUSCH Msg3, i.e., a third message of a four-step random access procedure of 3GPP specifications), or SRS transmissions. The uplink transmissions may correspond to the same (one or more) UCI(s) or same (one or more) TB(s) (or codewords), for example spatial or frequency division multiplexed transmissions, spatial or frequency division multiplexed PUCCH repetitions, spatial or frequency division multiplexed PUSCH repetitions, or the like. The first and second uplink transmissions may therefore comprise uplink repetitions sharing same data content. The uplink transmissions may be therefore also referred to as uplink repetitions. Alternatively, the uplink transmissions may comprise different data content, for example different UCI(s) or different TB(s), for example separate PUCCH or PUSCH transmissions in multi-DCI M-TRP operation. The first and second uplink transmissions may also comprise frequency division multiplexed uplink transmission occasions where one transmission occasion may transmit one subset of the full frequency resource allocation and another transmission occasion may transmit another subset of the full frequency resource allocation, for example in case of PUCCH frequency division multiplexed transmissions. The uplink transmissions may therefore comprise different data content, for example different subsets of data content of certain frequency resource allocation.

It should be noted that, parallel uplink transmissions, such as transmissions at least partially overlapping in time, may occur either in the same serving cell or bandwidth part, or in different serving cells or bandwidth parts. For example, in case of a configured supplementary uplink (SUL), the parallel uplink transmissions may occur on the same carrier or on different carriers (in the same cell). The parallel uplink transmissions may occur in the same cell or in cells having different physical cell identifier (ID).

The uplink configurations may comprise different transmission parameters for (at least partially) overlapping uplink transmissions towards different TRPs, for example in terms of initial cyclic shift (CS), orthogonal cover code (OCC), reference signal (e.g. DMRS) sequence initialization, scrambling sequence initialization, or scrambling sequence or identity. An initial cyclic shift may be applied to a transmitted sequence, such for example a sequence for PUCCH Format 0 transmission. Each cyclic shift may comprise to a shift of the sequence in time domain or phase rotation of the sequence in frequency domain. The sequence may comprise complex-valued symbols. Initial cyclic shift may define which cyclic shift UE 110 should start with, e.g. from twelve predefined values for the cyclic shift. Then, based on the payload (e.g., 1-bit or 2-bit HARQ-ACK), UE 110 may determine which cyclic shift to use, for example depending on the value of the HARQ-ACK bit(s). By using different parameters for the first and second transmission, some level of orthogonality may be created for the transmissions and/or the interference between the parallel uplink transmissions/repetitions may be randomized. Hence, if an uplink transmission which is intended towards one TRP, is e.g. reflected and also received at another TRP, the impact of such ‘interference’ is reduced/avoided (when the UL transmission are overlapping in frequency) as this other TRP will use its corresponding parameters for the detection (e.g. by cross correlation considering a relevant cyclic shift, by using corresponding code for OCC, by descrambling, or the like). The scrambling sequence may be used for scrambling data content of the transmission, e.g. PUSCH. Scrambling may be also used for scrambling control information, for example for PUCCH, scrambling control information after coding the PUCCH transmission.

For example, a first uplink configuration may comprise a first initial cyclic shift, a first orthogonal cover code, a first reference signal (sequence) initialization, a first scrambling sequence initialization, and/or a first scrambling sequence for a first uplink transmission. A second uplink configuration may comprise a second initial cyclic shift, a second orthogonal cover code, a second reference signal (sequence) initialization, a second scrambling sequence initialization, and/or a second scrambling sequence for a second uplink transmission. These parameters, or values thereof, may be different for the first and second uplink transmissions.

The uplink transmission configurations may be associated with or configured for specific TRPs (e.g. via RRC). For example, a first uplink configuration may be associated with first TRP 120. A second uplink configuration may be associated with second TRP 122. A TRP may be identified based on any suitable parameter. For example, the transmission parameters may be associated with or configured for a specific TRP and/or by a control resource set pool index (CORESETPoolIndex), at least one control resource set identifier (CORESET ID), beam failure detection reference signal (BFD-RS) set, SRS resource set, and/or physical cell ID. An association between at least one of these parameters and the relevant uplink configuration may be indicated to UE 110, for example by first TRP 120. Based on any (one or more) of these parameters, UE 110 may determine the uplink configurations for the TRPs. For example, first TRP 120 may be identified based on a first CORESETPoolIndex, a first CORESET ID, a first BFD-RS set, a first SRS resource set, or a first physical cell ID. Second TRP 122 may be identified based on a second CORESETPoolIndex, a second CORESET ID, a second BFD-RS set, a second SRS resource set, or a second physical cell ID. Alternatively, or additionally, any of the above parameters may be associated (e.g. via RRC, MAC CE, DCI) with one or more uplink beams or one or more SRIs or one or more uplink power control parameter sets.

At operation 302, first TRP 120 may transmit an indication of a set of uplink transmission resources or uplink transmissions format(s) associated with the uplink configurations of operation 301. The indication of the association of the uplink configurations with the set of uplink transmission resources or the uplink transmission format may be provided in RRC signaling. UE 110 may receive the indication. Alternatively, the association between the set of uplink transmission resources or uplink transmission format(s) may be preconfigured at UE 110. However, providing the indication by first TRP 120 enables configuration of the parallel uplink transmissions by the network.

For example, a PUCCH transmission resource, a PUCCH format (e.g. any of formats 0 to 4) or a set/group of PUCCH resources, may be configured with at least the first initial cyclic shift and the second initial cyclic shift. As another example, a PUCCH transmission resource, a PUCCH format or a set/group of PUCCH resources, may be configured (e.g. via RRC) with at least the first and second OCC, for example time-domain OCC or frequency-domain OCC. The OCCs may be represented for example by an OCC index and/or OCC length. A PUCCH transmission resource, PUCCH format or a set/group of PUCCH resources may be configured with at least the first and second cyclic shift offsets. A set of uplink transmission resources may comprise one or more uplink transmission resources. A group of uplink transmission resources may comprise a plurality of uplink transmission resources.

At operation 303, UE 110 may determine whether there are at least two overlapping uplink transmissions. UE 110 may for example determine that uplink transmissions towards different TRPs at least partially overlap in time domain. As noted above, the uplink transmissions may or may not overlap in frequency domain. UE 110 may for example determine that a first uplink transmission and a second uplink transmission are overlapping. Alternatively, or additionally, UE 110 may determine whether there is at least one non-overlapping uplink transmission. A non-overlapping uplink transmission may comprise an uplink transmission that is not overlapping with other uplink transmissions, for example in time domain.

At operation 304, UE 110 may determine uplink configurations for the transmissions towards the different TRPs. For example, in response determining (at operation 303) that the first uplink transmission and the second uplink transmission at least partially overlap in time domain, UE 110 may determine to transmit the first uplink transmission with the first uplink configuration and the second uplink transmission with the second uplink configuration. UE 110 may determine to transmit a non-overlapping uplink transmission with the first uplink configuration, the second uplink configuration, or a default uplink configuration. The default uplink configuration may be preconfigured at UE 110. The default uplink configuration may comprise values for parameter(s) similar to the first and second uplink configurations.

The first and second uplink configurations may comprise configurations indicated at operation 301. Alternatively, if UE 110 is not configured by the network (e.g. first TRP 120) with the first and second configurations of the relevant transmission parameter(s) (e.g. value(s) thereof), UE 110 may determine and/or apply first and second default values for the first and second uplink transmissions, respectively. The default values may be preconfigured at UE 110. In case of M-TRP FDM or TDM scheme, for any of the above parameters, a single (e.g. first) parameter, having a value between a first parameter of the first uplink configuration and a second parameter of the second uplink configuration, may be used for the parallel uplink transmissions.

At operations 305 and 306, UE 110 may transmit the first and second overlapping uplink transmissions. Operations 305 and 306 may occur at least partially simultaneously such that the first and second uplink transmissions at least partially overlap in time domain. The first uplink transmission may be transmitted with the first uplink configuration, for example with a first initial cyclic shift, a first orthogonal cover code, a first reference signal initialization, a first scrambling sequence initialization, and/or a first scrambling sequence, as determined at operation 304. The second uplink transmission may be transmitted with the second uplink configuration, for example with a second initial cyclic shift, a second orthogonal cover code, a second reference signal (sequence) initialization, a second scrambling sequence initialization, and/or a second scrambling sequence, as determined at operation 304. First TRP 120 may receive the first uplink transmission. For example, first TRP 120 may demodulate the first transmission using the first uplink configuration, for example the first initial cyclic shift, the first orthogonal cover code, the first reference signal initialization, the first scrambling sequence initialization, the first scrambling sequence, and/or a first cyclic shift for DMRS. Interference caused by the second transmission (cf. operation 310) may be therefore reduced or avoided. Second TRP 122 may receive the second uplink transmission. For example, second TRP 120 may demodulate the second transmission using the second uplink configuration, for example the second initial cyclic shift, the second orthogonal cover code, the second reference signal initialization, the second scrambling sequence initialization, the second scrambling sequence, and/or a second cyclic shift for DMRS. Interference caused by the first transmission (cf. operation 309) may be therefore reduced or avoided. A non-overlapping transmission may be transmitted with the first uplink configuration, the second uplink configuration, or the default uplink configuration.

As noted above, determining the uplink configurations may be based on the association of the intended uplink transmission resources or format to the first and second uplink configurations. In this case, UE 110 may transmit the first uplink transmission with the first uplink configuration and the second uplink transmission with the second uplink configuration, in response to determining that at least one uplink transmission resource determined for the first uplink transmission and the second uplink transmission belong to the associated set of uplink transmission resources or that the first and second uplink transmissions are transmitted with the associated uplink transmission format.

For example, if UE 110 is indicated or has determined to use certain PUCCH transmission resource(s) or format for the two uplink transmissions, and these transmission resource(s) or PUCCH format is/are associated with first and second uplink configurations for the initial cyclic shift, UE 110 may use the first initial cyclic shift for the first uplink transmission and the second initial cyclic shift for the second uplink transmission. Each PUCCH transmission, considering the first and second initial cyclic shifts, may be received at corresponding TRP 120, 122 (or a node in general). Each TRP 120, 122 may apply respective/corresponding initial cyclic shift for detecting one of the PUCCH transmission. First TRP 120 may consider the PUCCH transmission that is associated with the other initial cyclic shift (targeted for second TRP 122) as an interfering transmission for detecting the PUCCH transmission towards first TRP 120.

As another example, if UE 110 is indicated or has determined to use the indicated or pre-configured PUCCH resource(s) or PUCCH format for the two uplink transmissions, and these transmission resource(s) or PUCCH format is/are associated with first and second uplink configurations for OCC, UE 110 may use a first OCC for the first uplink transmission and a second OCC for the second UL transmission. Each UL/PUCCH transmission, considering the first and second OCCs, may be received at corresponding TRP 120, 122. Each TRP 120, 122 may apply respective/corresponding OCC for detecting one of the PUCCH transmission. First TRP 120 may consider the PUCCH transmission that is associated with the other OCC (targeted for second TRP 122) as an interfering transmission for detecting the uplink/PUCCH transmission.

Furthermore, if the first uplink transmission and the second uplink transmission use (i) first reference signal sequence initialization and second reference signal sequence initialization, respectively, or (ii) first scrambling sequence initialization and second scrambling sequence initialization, respectively, or (iii) first scrambling sequence and second scrambling sequence, respectively, each uplink transmission, considering the first and second parameters of (i), (ii) or (iii), may be received at respective TRP 120, 122. Each TRP 120, 122 may apply respective/corresponding parameter for detecting one of the uplink transmissions. One node may consider the UL transmission that is associated with another parameter (of (i), (ii) or (iii)) as an interfering transmission for detecting the uplink transmission.

The first and second transmissions towards the TRPs 120, 122 may be directional, i.e., directed towards a respective TRP. The uplink transmissions may be for example transmitted from a different UE antenna panel and thus essentially towards different TRPs. For example, UE 110 may transmit the first uplink transmission using a first antenna panel directed towards first TRP 120 and the second uplink transmission using a second antenna panel directed towards second TRP 122. Alternatively, UE 110 may implement the directional transmission towards the two TRPs by means of two uplink beams, SRIs, or (UL) TCI states. Such means may be applied for example in FR2. UE 110 may also apply two power control parameters sets or SRIs. This option may be applied for example in FR1. As noted above, an uplink beam may also refer to spatial relation info, (separate) uplink TCI state, joint or common TCI state, spatial filter, power control info or power control parameter set, antenna panel or antenna panel ID. The first uplink transmission and second uplink transmission may be mapped to a first (indicated) uplink beam and a second (indicated) uplink beam, respectively.

In one example, the uplink configurations may comprise first and second reference signal sequence initializations for DMRSs of the first and second uplink transmissions, respectively. In this case, the cyclic shifts and/or OCCs included in the uplink configurations may be applied to the respective DMRSs. For example, UE 110 may use a first cyclic shift or a first OCC for the DMRS of the first uplink transmission. UE 110 may use a second cyclic shift or a second OCC for the DMRS of the second uplink transmission. This enables to create some orthogonality for the DMRSs of the two overlapping uplink transmissions occupying the same transmission resources by using different CSs or OCCs for the DMRS

At operation 307, first TRP 120 may transmit an indication to use or not to use different uplink configurations for parallel (overlapping) transmissions, e.g. to use or not to use the second uplink configuration for the second uplink transmission. This enables the network to indicate, for example via DCI (or even more generally via the PDCCH carrying DCI, e.g. by using dedicated RNTI (e.g. to indicate ‘use’ or ‘not use’ different UL configurations), dedicated CORESET(s) or Search Space set(s), dedicated DCI format, etc.) or MAC CE whether or not to use the second uplink configuration, for example the second initial cyclic shift, the second OCC, the second DMRS sequence initialization, the second scrambling sequence initialization, and/or the second scrambling sequence or identity, for the two parallel uplink transmissions. The indication may be provided dynamically, for example via DCI or MAC CE. This provides a gNB (e.g. first TRP 120 or second TRP 122) with an opportunity to dynamically control whether UE 110 should use different uplink configurations or not, depending on a given scenario or situation (e.g. in case of parallel UL transmission that are not overlapping in frequency, or if little interference from one UL transmission to the other one is expected, etc.). UE 110 may receive the dynamic indication of not to use different uplink configuration for the parallel uplink transmissions. Consequently, UE 110 may be configured to use same uplink configuration for both parallel uplink transmissions.

At operation 308, UE 110 may determine not to use different uplink configurations for the overlapping uplink transmissions, e.g. the second uplink configuration for the second uplink transmission. Instead, UE 110 may determine to use the first uplink configuration also for the second uplink transmission.

At operations 309 and 310, UE 110 may transmit another set (e.g. a pair) of first and second uplink transmissions, which may be also referred to as subsequent instances of the first and second uplink transmissions. Operations 309 and 310 may occur at least partially simultaneously such that the subsequent instances of first and second uplink transmissions at least partially overlap in time domain. Considering the dynamic indication of operation 307, both the first and second uplink transmissions may be transmitted with the first uplink configuration, as determined in operation 308.

It is however noted that provision of the dynamic indication at operation 307 is optional. If no such indication is received, UE 110 may transmit the subsequent instances of the first and second uplink transmissions with the first and second uplink configurations, similar to operations 305 and 306. It is however possible that the uplink configurations of the parallel transmissions are swapped. For example, the first uplink transmission of operation 309 may be transmitted with the second uplink configuration (swapped from the first uplink configuration of operation 305) and the second uplink transmission of operation 310 may be transmitted with the first uplink configuration (swapped from the second uplink configuration of operation 306).

For example, for the initial cyclic shift, the association or mapping of the first initial cyclic shift and the second initial cyclic shift to the two parallel uplink transmissions may be swapped from a previous pair of parallel uplink transmissions (or repetitions) to a subsequent pair of parallel uplink transmissions (or repetitions). The pairs of uplink transmissions may be consecutive in time. Similarly, for any other transmission parameters (e.g. OCC, reference signal sequence initialization, scrambling sequence initialization, scrambling sequence or identity) the mapping of the first and second parameters to the uplink transmissions may be swapped between pairs (e.g. consecutive pairs) of parallel uplink transmissions.

Referring to operations 309 and 310, UE 110 may therefore alternatively transmit (cf. operation 309) a subsequent instance of the first uplink transmission with the second uplink configuration towards first TRP 120 and transmit (cf. operation 310) a subsequent instance of the second uplink transmission with the first uplink configuration to second TRP 122. Again, the transmissions may be directional towards the respective TRPs.

To configure the swapping operation, first TRP 120 may transmit a request for swapping uplink configurations for subsequent pair(s) of uplink transmissions at least partially overlapping in time domain. UE 110 may perform swapping of the uplink configurations for (consecutive) pairs of the uplink transmissions, in response to receiving the request for enabling the swapping, for example from first TRP 120.

Operations of FIG. 3 enable configuration of uplink transmission configurations for parallel uplink transmissions in a multi-TRP scenario, thereby reducing interference between the parallel uplink transmissions.

According to a further example, parameter(s) distinguishing the first and second uplink configurations may be determined, for example by first TRP 120 or another network node or function, based on the transmission format, e.g. the PUCCH format. For example, for a PUCCH resource with format 0, the PUCCH resource (or PUCCH format 0) may be configured (e.g. via RRC as part of the PUCCH configuration) with a first initial cyclic shift and a second initial cyclic shift. For a PUCCH resource with format 1: the PUCCH resource (or PUCCH format 1) may be configured (e.g. via RRC as part of the PUCCH configuration) with at least one of (i) a first time-domain OCC and a second time-domain OCC, or (ii) a first initial cyclic shift and a second initial cyclic shift. For a PUCCH resource with format 4: the PUCCH resource (or PUCCH format 4) may be configured (e.g. via RRC as part of the PUCCH configuration) with at least one of (i) a first OCC index and a second OCC index, or (ii) a first OCC length and a second OCC length. For PUCCH resource with format 2, 3, or 4: first and second DMRS sequence initializations may be configured in DMRS uplink configuration and/or the PUSCH configuration. For PUCCH resource with format 2, 3, or 4: first and second scrambling sequence initializations and/or first and second scrambling sequence identities may be configured (e.g. via RRC) as part of the PUSCH configuration and/or as part of the PUCCH configuration.

According to a further example, a first DMRS scrambling initialization or scrambling ID and a second DMRS scrambling initialization or scrambling ID may be configured for UE 110 for example in at least one of the following cases: transform precoding enabled, transform precoding disabled. Transform precoding may be disabled for example when CP-OFDM (cyclic prefix OFDM) is applied. Transform precoding may be enabled for example when DFT-S-OFDM (discrete Fourier transform spread OFDM) is applied. An indication of the first and second DMRS scrambling initializations may be transmitted to UE 110, e.g. by first TRP 120, for example in DMRS uplink configuration and/or the PUSCH configuration. These initializations may be configured per DCI format, such as for example DCI format 0_1 and 0_2. Also, these initializations may be configured per PUSCH mapping type.

An indication of first and second DMRS sequence initializations, first and a second scrambling sequence initializations (e.g. termed as first and second PUSCH data scrambling ID), and/or a first and a second scrambling sequence identities may be transmitted to UE 110, for example by first TRP 120 (e.g. via RRC), for example as part of the PUSCH configuration (including also configured-grant PUSCH configuration(s) and MsgA PUSCH configuration). MsgA may comprise a first message of a two-step random access procedure of 3GPP standards.

The first and/or second DMRS sequence initializations may be indicated to UE 110 via DCI (e.g. DCI format 0_1/0_2, scheduling PUSCH or activating configured-grant PUSCH Type 2). For example, if the DMRS sequence initialization one-bit field is reused, this one bit may be then configured to indicate two DMRS sequence initializations.

According to a further example, at least one of (i) first initial cyclic shift and/or second initial cyclic shift, (ii) first time-domain OCC and/or second time-domain OCC, (iii) first OCC index and/or second OCC index, (iv) first OCC length and/or second OCC length, or first and/or second DMRS sequence initialization may be indicated via DCI—such as for example downlink DCI corresponding to the UCI/PUCCH.

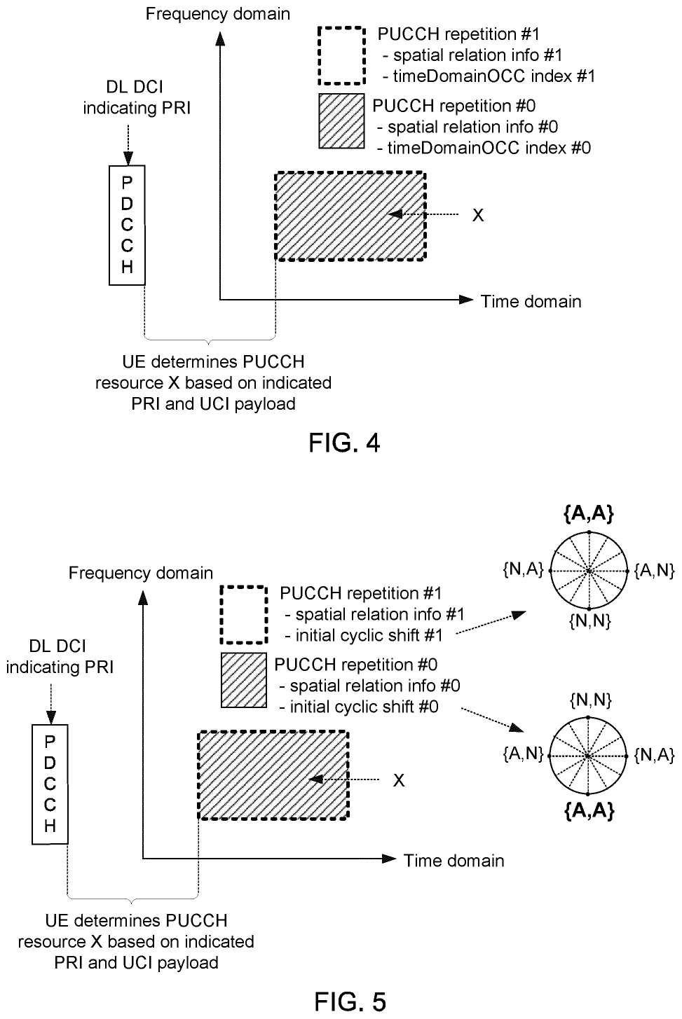

FIG. 4 illustrates an example of applying different orthogonal cover codes for overlapping uplink transmissions to two transmission-reception points. In this example, a PUCCH resource “X” is associated (e.g. via RRC) to a first time domain OCC index (#0) and a second time domain OCC index (#1). Also, PUCCH resource “X” is assumed to be indicated/associated with two spatial relation infos (#0 and #1). UE 110 may determine PUCCH resource “X” based on the indicated PUCCH resource index (PRI) and UCI payload. An indication of the PRI may be received in DCI, for example from first TRP 120. DCI may be received on PDCCH.

This example relates to a multi-TRP scheme, where PUCCH repetition #1 (dashed perimeter) and PUCCH repetition #0 (diagonally dashed) are fully overlapping in time and frequency, corresponding to an M-TRP PUCCH SDM scheme. UE 110 may apply the first time domain OCC (index #0) to the first repetition (repetition #0) and the second time domain OCC (index #1) to the second repetition (repetition #1). In general, the first and second parallel uplink transmissions may be associated with first and second (different) OCCs, respectively. Furthermore, the first and second uplink transmissions/repetitions may be associated with first and second (different) spatial relation infos, respectively.

FIG. 5 illustrates an example of applying different initial cyclic shifts for overlapping uplink transmissions towards two transmission-reception points. In this example, a PUCCH resource “X” is associated (e.g. via RRC) with two initial cyclic shifts: a first initial cyclic shift, initialCyclicShift #0 which is equal to zero, and a second initial cyclic shift, initialCyclicShift #1 which is equal to six. In total there may be twelve possible cyclic shifts as illustrated by the dotted lines inside the circles. Also, PUCCH resource “X” is assumed to be indicated/associated with two spatial relation infos (#0 and #1).

UE 110 may determine PUCCH resource “X” based on the indicated PRI and UCI payload, similar to FIG. 4. In this example, the length of the UCI payload is two bits. Also this example relates to a multi-TRP scheme, where PUCCH repetition #1 (dashed perimeter) and PUCCH repetition #0 (diagonally dashed) are fully overlapping in time and frequency. The two UCI bits may for example comprise two HARQ-ACK bits {A,A} (i.e. {1,1}). UE 110 may then use initialCyclicShift #0 (equal to 0) and initialCyclicShift #1 (equal to six) and the cyclic shift corresponding to {A, A} to determine the cyclic shifts to use for PUCCH repetition #0 and PUCCH repetition #1, respectively. PUCCH repetition #1 may be transmitted with spatial relation info #1 and PUCCH repetition #0 may be transmitted with spatial relation info #0. As noted above, the initial cyclic shift and the value(s) of the bit(s) may be used to determine the cyclic shift to use for each uplink transmission (e.g. PUCCH repetition). For example, the initial cyclic shifts for the first and second uplink transmissions may be configured to result in cyclic shifts that are maximally distant from each other, as illustrated in FIG. 5. In general, first and second parallel uplink transmissions may be associated with first and second (different) initial cyclic shifts, respectively, applicable for example for payload data of the uplink transmissions. Furthermore, the first and second uplink transmissions may be associated with first and second (different) spatial relation infos, respectively.

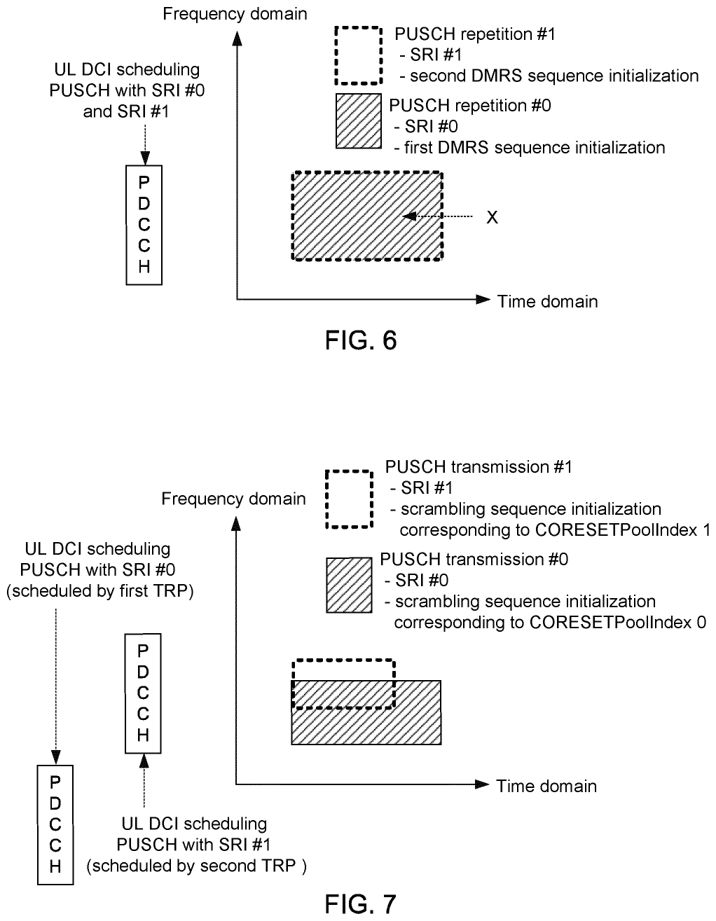

FIG. 6 illustrates an example of applying different demodulation reference signal (DMRS) sequence initializations for overlapping uplink transmissions to two transmission-reception points. This example relates to configuration of two PUSCH repetitions. UE 110 may be configured, for example by first TRP 120 (e.g. in PUSCH configuration and/or DMRS uplink configuration), with a first DMRS sequence initialization and a second DMRS sequence initialization for the first and second PUSCH repetitions. UE 110 may receive, for example on PDCCH carrying UL DCI scheduling the PUSCH repetitions, an indication of two SRIs, (SRI #0 and SRI #1) for first and second PUSCH repetitions. This example relates to a multi-TRP scheme, where PUSCH repetition #1 (dashed perimeter) and PUSCH repetition #0 (diagonally dashed) are fully overlapping in time and frequency, corresponding e.g. to an M-TRP PUSCH SDM scheme. UE 110 may apply the first DMRS sequence initialization to the first repetition (PUSCH repetition #0) and the second DMRS sequence initialization to the second repetition (PUSCH repetition #1). In general, first and second uplink transmissions may be associated with first and second (different) DMRS sequence initializations, respectively. Furthermore, the first and second uplink transmissions may be associated with first and second (different) SRIs.

FIG. 7 illustrates an example of applying different scrambling sequence initializations for partially overlapping uplink transmissions to two transmission-reception points. Also this example relates to configuration of two PUSCH transmissions. In this example, first TRP 120, represented by CORESETPoolIndex 0, is configured or associated with a first (PUSCH/UL) scrambling sequence initialization and second TRP 122, represented by CORESETPoolIndex 1, is configured or associated with a second (PUSCH/UL) scrambling sequence initialization.

First TRP 120 may transmit to UE 110, for example on PDCCH, uplink DCI scheduling a PUSCH transmission #0 with SRI #0. Second TRP 122 may transmit to UE 110, for example on PDCCH, uplink DCI scheduling a PUSCH transmission #1 with SRI #1, where PUSCH transmission #0 and PUSCH transmission #1 are partially overlapping in time and frequency, corresponding to multi-TRP multi-DCI operation. Thus, UE 110 may use the first and second scrambling sequence initializations, corresponding to CORESETPoolIndex 0 and 1, respectively, for PUSCH transmission #0 and PUSCH transmission #1, respectively.

In this example, the first PDCCH transmission (i.e. the one carrying UL DCI scheduling PUSCH with SRI #0) may be transmitted on a CORESET corresponding to CORESETPoolIndex 0. The second PDCCH (i.e. the one carrying UL DCI scheduling PUSCH with SRI #1) may be transmitted on a CORESET corresponding to CORESETPoolIndex 1. Hence, UE 110 is aware of which scrambling sequence initialization to use for each PUSCH transmission based on the CORESET on which the corresponding PDCCH is transmitted.

It is noted that even if the example of FIG. 7 relates to (UL/PUSCH) scrambling sequence, similar functionality may be used when considering reference signal sequence initialization or scrambling sequences. For example, an association may be provided between TRP or CORESETPoolIndex and reference signal sequence initialization or scrambling sequence. It's also worth noting that similar functionality may be applied to PUCCH, where for example initial cyclic shift or OCC may be associated with a TRP or a CORESETPoolIndex. For instance, same PUCCH resource, PUCCH format, or a set/group of PUCCH resources may be configured with two initial cyclic shifts or two OCCs and two DCIs (e.g. similar to those of FIG. 7) may be configured to indicate the same PUCCH resource. Thus, UE 110 may be informed about which cyclic shift or OCC to use for each PUCCH transmission.

Various example embodiments of the present disclosure thus enable to combat interference between two parallel uplink transmissions or repetitions, for example when considering multi-TRP space division multiplexed uplink transmission or repetition operations. Example embodiments also enable to improve uplink resource efficiency.

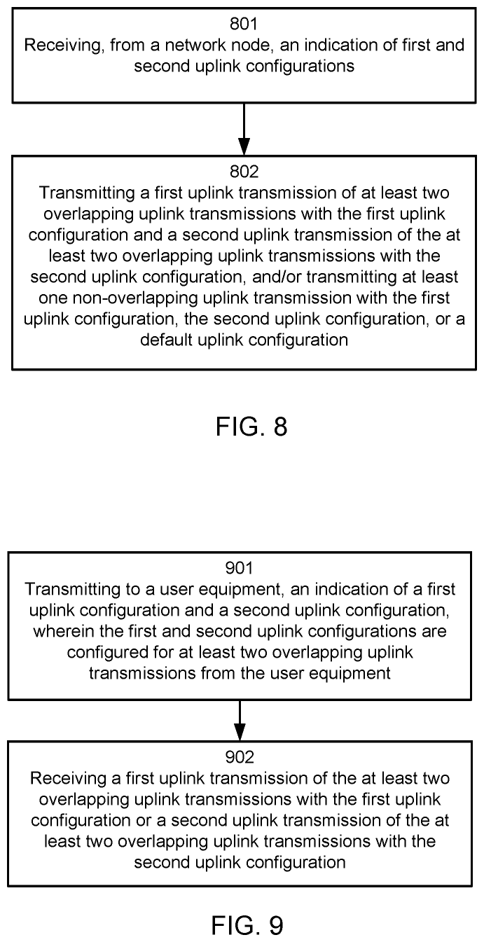

FIG. 8 illustrates an example of a method for applying different uplink transmission configurations for uplink transmissions.

At 801, the method may comprise receiving, from a network node, an indication of first and second uplink configurations.

At 802, the method may comprise transmitting a first uplink transmission of at least two overlapping uplink transmissions with the first uplink configuration and a second uplink transmission of the at least two overlapping uplink transmissions with the second uplink configuration, and/or transmitting at least one non-overlapping uplink transmission with the first uplink configuration, the second uplink configuration, or a default uplink configuration.

FIG. 9 illustrates an example of a method for configuring different uplink transmission configurations for uplink transmissions.

At 901, the method may comprise transmitting to a user equipment, an indication of a first uplink configuration and a second uplink configuration, wherein the first and second uplink configurations are configured for at least two overlapping uplink transmissions from the user equipment.

At 902, the method may comprise receiving a first uplink transmission of the at least two overlapping uplink transmissions with the first uplink configuration or a second uplink transmission of the at least two overlapping uplink transmissions with the second uplink configuration.

Further features of the methods directly result from the functionalities and parameters of the UE 110, TRPs 120, 122, or in general apparatus 200, as described in the appended claims and throughout the specification, and are therefore not repeated here. Different variations of the methods may be also applied, as described in connection with the various example embodiments.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code;
the at least one memory and the computer program code configured to, with the at least one processor, cause the apparatus at least to:
receive, from a network node, an indication of first and second uplink configurations; and
transmit a first uplink transmission of at least two overlapping uplink transmissions with the first uplink configuration and a second uplink transmission of the at least two overlapping uplink transmissions with the second uplink configuration, and/or transmit at least one non-overlapping uplink transmission with the first uplink configuration, the second uplink configuration, or a default uplink configuration.

2. The apparatus according to claim 1, wherein the first and second uplink transmission configurations comprise at least one of:
a first initial cyclic shift for the first uplink transmission and a second initial cyclic shift for the second uplink transmission,
a first orthogonal cover code for the first uplink transmission and a second orthogonal cover code for the second uplink transmission,
a first reference signal initialization for the first uplink transmission and a second reference signal initialization for the second uplink transmission,
a first scrambling sequence initialization for the first uplink transmission and a second scrambling sequence initialization for the second uplink transmission, or
a first scrambling sequence for the first uplink transmission and a second scrambling sequence for the second uplink transmission.

3. The apparatus according to claim 1, wherein the at least one memory and the computer program code are further configured to, with the at least one processor, cause the apparatus to:
directionally transmit the first uplink transmission towards a first transmission-reception point; and
directionally transmit the second uplink transmission towards a second transmission-reception point.

4. The apparatus according to claim 1, wherein the indication of the first uplink configuration and the second uplink configuration is received in at least one of downlink control information, medium access control control element, or radio resource control signaling.

5. The apparatus according to claim 1, wherein the at least one memory and the computer program code are further configured to, with the at least one processor, cause the apparatus to:
receive an indication of an association of the first uplink configuration and the second uplink configuration with a set of uplink transmission resources or an uplink transmission format.

6. The apparatus according to claim 5, wherein the indication of the association of the first uplink configuration and the second uplink configuration with the set of uplink transmission resources or the uplink transmission format is received in radio resource control signaling.

7. The apparatus according to claim 1, wherein the first and second uplink transmissions comprise at least one of: uplink repetitions sharing same data content, different data content, or different subsets of data content of a frequency resource allocation.

8. The apparatus according to claim 3, wherein the first uplink configuration is associated with or configured for the first transmission-reception point and the second uplink configuration is associated with or configured for the second transmission-reception point

9. The apparatus according to claim 8, wherein the first transmission-reception point is identified based on at least one of a first control resource set pool index, a first control resource set identifier, a first beam failure detection reference signal set, a first sounding reference signal resource set, or a first physical cell identifier, and wherein the second transmission-reception point is identified based on at least one of a second control resource set pool index, a second control resource set identifier, a second beam failure detection reference signal set, a second sounding reference signal resource set, or a second physical cell identifier.

10. The apparatus according to claim 2, wherein the at least one memory and the computer program code are further configured to, with the at least one processor, cause the apparatus to:
use the first reference signal initialization for a demodulation reference signal of the first uplink transmission; and
use the second reference signal initialization for a demodulation reference signal of the second uplink transmission.

11. The apparatus according to claim 10, wherein the at least one memory and the computer program code are further configured to, with the at least one processor, cause the apparatus to:
use a first cyclic shift or the first orthogonal cover code for the demodulation reference signal of the first uplink transmission; and
use a second cyclic shift or the second orthogonal cover code for the demodulation reference signal of the second uplink transmission.

12. The apparatus according to claim 1, wherein the at least one memory and the computer program code are further configured to, with the at least one processor, cause the apparatus to:
receive an indication to use or not to use different uplink configurations for the at least two overlapping uplink transmissions; and
determine to use or not to use one of the first and second uplink configurations for subsequent instances of the first and second uplink transmissions based on the indication to use or not to use the different uplink configurations.

13. The apparatus according to claim 3, wherein the at least one memory and the computer program code are further configured to, with the at least one processor, cause the apparatus to:
directionally transmit a subsequent instance of the first uplink transmission with the second uplink configuration towards the first transmission-reception point; and
directionally transmit a subsequent instance of the second uplink transmission with the first uplink configuration to the second transmission-reception point.

14. An apparatus, comprising:
at least one processor; and
at least one memory including computer program code;
the at least one memory and the computer program code configured to, with the at least one processor, cause the apparatus at least to:
transmit to a user equipment, an indication of a first uplink configuration and a second uplink configuration, wherein the first and second uplink configurations are configured for at least two overlapping uplink transmissions from the user equipment; and
receive a first uplink transmission of the at least two overlapping uplink transmissions with the first uplink configuration or a second uplink transmission of the at least two overlapping uplink transmissions with the second uplink configuration.

15. The apparatus according to claim 14, wherein the first and second uplink configurations comprise at least one of:
a first initial cyclic shift for the first uplink transmission and a second initial cyclic shift for the second uplink transmission,
a first orthogonal cover code for the first uplink transmission and a second orthogonal cover code for the second uplink transmission,
a first reference signal initialization for the first uplink transmission and a second reference signal initialization for the second uplink transmission,
a first scrambling sequence initialization for the first uplink transmission and a second scrambling sequence initialization for the second uplink transmission, or
a first scrambling sequence for the first uplink transmission and a second scrambling sequence for the second uplink transmission.

16. The apparatus according to claim 14, wherein the indication of the first uplink configuration and the second uplink configuration is transmitted in at least one of downlink control information, medium access control element, or radio resource control signaling.

17. The apparatus according to claim 14, wherein the at least one memory and the computer program code are further configured to, with the at least one processor, cause the apparatus to:
transmit an indication of an association of the first uplink configuration and the second uplink configuration with a set of uplink transmission resources or an uplink transmission format.

18-21. (canceled)

22. The apparatus according to claim 14, wherein the at least one memory and the computer program code are further configured to, with the at least one processor, cause the apparatus to:
transmit an indication to use or not to use the second uplink configuration for the at least two overlapping uplink transmissions.

23. The apparatus according to claim 14, wherein the at least one memory and the computer program code are further configured to, with the at least one processor, cause the apparatus to:
transmit a request for swapping uplink configurations for at least one subsequent pair of overlapping uplink transmissions.

24. A method, comprising:
receiving, from a network node, an indication of first and second uplink configurations; and
transmitting a first uplink transmission of at least two overlapping uplink transmissions with the first uplink configuration and a second uplink transmission of the at least two overlapping uplink transmissions with the second uplink configuration, and/or transmitting at least one non-overlapping uplink transmission with the first uplink configuration, the second uplink configuration, or a default uplink configuration.

25-29. (canceled)
